(19) United States
(12) Patent Application Publication
(10) Pub. No.: US 2012/0107517 A1
(43) Pub. Date: May 3, 2012

(54) METHOD OF MANUFACTURING OPTICAL WAVEGUIDE FOR TOUCH PANEL

(75) Inventors: Naoki Shibata, Osaka (JP); Toru Mizutani, Osaka (JP); Yusuke Shimizu, Osaka (JP); Mutsumi Kawabata, Yokohama-shi (JP)

(73) Assignee: NITTO DENKO CORPORATION, Osaka (JP)

(21) Appl. No.: 13/276,500

(22) Filed: Oct. 19, 2011

(30) Foreign Application Priority Data
Oct. 27, 2010 (JP) 2010-240995

(51) Int. Cl. G02B 6/138

(52) U.S. Cl. 427/508

(57) ABSTRACT

A method of manufacturing an optical waveguide for a touch panel is provided which achieves a small dimensional change due to heat to provide precise formation positions of a cladding layer and cores on a substrate. The method includes: selecting an elongated substrate made of stainless steel to continuously apply a first photosensitive resin composition; heating the first photosensitive resin composition to volatilize a solvent therein; irradiating the first photosensitive resin composition to form the cladding layer; continuously applying a second photosensitive resin composition; heating the second photosensitive resin composition to volatilize a solvent therein; and irradiating the second photosensitive resin composition with irradiation light through a photomask to expose the second photosensitive resin composition to the irradiation light, and thereafter dissolving away unexposed portions of the second photosensitive resin composition by using a developing solution.

### BACKGROUND OF THE INVENTION

1. Field of the Invention

The present invention relates to a method of manufacturing an optical waveguide for a touch panel.

2. Description of the Related Art

Conventionally, an optical detection means for optically detecting the position of a finger and the like by the use of an optical waveguide is used as one of the means for detecting a touch position on a touch panel, as disclosed in Japanese Published Patent Application No. 2010-20103.

This optical detection means is configured such that a light-emitting section of a light-emitting optical waveguide provided on left-hand and right-hand side portions on opposite sides of a corner of a rectangular panel emits (projects) multiple light beams (substantially parallel light beams) toward other side portions opposed to the left-hand and right-hand side portions, with a detection region of the panel therebetween, to form a lattice of light beams within the detection region, and such that a light-receiving element or the like detects light beams incident on a light-receiving section of a light-receiving optical waveguide provided on the other side portions of the panel. In this state, when an object such as a finger blocks some of the light beams in the form of a lattice within the aforementioned detection region, the light-receiving element or the like connected to the light-receiving optical waveguide senses where some light beams are blocked, so that the location (i.e., X and Y coordinates) of a portion touched with the finger or the like is specified.

In recent years, a light-weight and flexible polymer optical waveguide which uses a polymeric resin material has been developed and started being used as the aforementioned optical waveguide for a touch panel. This polymer optical waveguide is manufactured, for example, in a manner to be described below. Specifically, a photosensitive resin composition for a cladding layer is initially used to form a cladding layer (an under cladding layer) on a substrate. Then, a photosensitive resin composition for cores having a refractive index different from that of the cladding layer is applied onto the cladding layer. The surface of this photosensitive resin composition is dried by preheating (pre-baking). Thereafter, the surface coated with the aforementioned photosensitive resin composition is irradiated with and exposed to light through a mask. Then, unexposed portions of the photosensitive resin composition are developed and removed using a developing solution. This provides an optical waveguide for a touch panel which has cores having a predetermined pattern on the cladding layer.

With regard to such a method of manufacturing an optical waveguide for a touch panel, a method has been proposed in which, by using a tape-shaped substrate made of polyethylene terephthalate (PET), polyethylene naphthalate (PEN), polyimide (PI) or the like as the substrate for an optical waveguide, a coating of a material for the formation of a cladding layer or a material for the formation of cores (varnish) is continuously applied to the substrate in a roll-to-roll fashion, whereby the optical waveguide for a touch panel is efficiently manufactured, as disclosed in Japanese Published Patent Application No. 2009-186834.

However, the method of manufacturing a polymer optical waveguide for a touch panel as described above presents problems to be described below when a coating process and a heating treatment are continuously performed to form the cladding layer or the cores in the optical waveguide. Specifically, before a photosensitive resin composition is exposed to light in the step of forming the cladding layer or the cores, heat at approximately 100 to 150° C. is applied to the photosensitive resin composition in the process of preheating (pre-baking) for vaporizing a solvent in the photosensitive resin to dry the surface. A polymer film made of PET, PEN or the like used as a carrier substrate for the optical waveguide thermally expands or contacts to change in dimension, thereby lowering the positional accuracy of the cladding layer and the cores on the substrate. This tendency increases when forces of unwinding and winding are applied to the polymer film in a roll-to-roll process.

The positional accuracy of the cores on the substrate is important when the optical waveguide is incorporated into a touch panel. When the optical axis of the cores in a light-emitting optical waveguide and the optical axis of the cores in a light-receiving optical waveguide do not coincide with each other, light beams from the light-emitting optical waveguide do not sufficiently reach a light-receiving element connected to the cores in the light-receiving optical waveguide. This gives rise to apprehension that an insufficient amount of light decreases the sensitivity of the touch panel. It is hence desirable to improve the positional accuracy in the stage of manufacture of the aforementioned optical waveguide.

### SUMMARY OF THE INVENTION

In view of the foregoing, a method of manufacturing an optical waveguide for a touch panel is provided which achieves a small dimensional change due to heat to provide precise formation positions of a cladding layer and cores on a substrate even when the method includes the step of continuously performing a coating process and a heating treatment to form the cladding layer and the cores in the optical waveguide.

The method of manufacturing an optical waveguide for a touch panel, which comprises the steps of: (a) selecting an elongated substrate made of stainless steel as a substrate to apply a first photosensitive resin composition for the formation of a cladding layer onto the substrate continuously in a longitudinal direction of the substrate; (b) heating the applied first photosensitive resin composition to volatilize a solvent in the first photosensitive resin composition; (c) irradiating the first photosensitive resin composition subjected to the step (b) with irradiation light to form a cladding layer; (d) applying a second photosensitive resin composition for the formation of cores onto the cladding layer continuously in the longitudinal direction of the substrate; (e) heating the applied second photosensitive resin composition to volatilize a solvent in the second photosensitive resin composition; and (f) irradiating the second photosensitive resin composition subjected to the step (e) with irradiation light through a photomask to expose the second photosensitive resin composition to the irradiation light, thereby completing the curing of the second photosensitive resin composition, and thereafter dissolving away unexposed portions of the second photosensitive resin composition by using a developing solution to form cores having a predetermined pattern.

Specifically, it has been found that the use of metal foil made of stainless steel having high rigidity as a substrate for supporting the optical waveguide for a touch panel causes the expansion due to heating and contraction due to resin curing to cancel out each other, thereby improving the dimensional stability of the optical waveguide under heat.

The method of manufacturing an optical waveguide for a touch panel uses the elongated substrate made of stainless steel as the substrate therefor. This suppresses a dimensional change due to the first preheating in the step (b) prior to the exposure for the cladding layer, and a dimensional change associated with the exposure and heat-curing process for curing the cladding layer. This also similarly suppresses a dimensional change due to the second preheating in the step (e) prior to the exposure for the cores, and a dimensional change associated with the exposure and heat-curing process for curing the cores. Therefore, the method of manufacturing an optical waveguide for a touch panel is less prone to cause expansion/contraction and a dimensional change during the formation of the cladding layer and the cores, and is capable of producing the cladding layer and the cores in predetermined positions on the substrate precisely and with high accuracy.

Preferably, at least the steps (a) and (b) and the steps (d) and (e) are performed continuously by a roll-to-roll process in which the elongated substrate in a wound condition is unwound and is then wound up after the completion of processing. This efficiently achieves the application of the photosensitive resin compositions which are the materials for the formation of the cladding layer and the cores, and the preheating (drying) thereof prior to the exposure. Additionally, the method of manufacturing an optical waveguide for a touch panel uses the elongated substrate made of stainless steel as the substrate therefore, as mentioned above. Thus, when forces of unwinding and winding are applied to the substrate as in the roll-to-roll process, the substrate withstands the forces. This prevents a dimensional change during the preheating of the photosensitive resin compositions for the cladding layer and for the cores, to achieve the high-accuracy production of the cladding layer and the cores in predetermined positions on the substrate.

### BRIEF DESCRIPTION OF THE DRAWINGS

FIGS. 1A to 1C are schematic views illustrating a process for forming a cladding layer in a method of manufacturing an optical waveguide for a touch panel according to a preferred embodiment.

FIGS. 2A to 2F are schematic views illustrating a process for forming cores in the method of manufacturing an optical waveguide for a touch panel according to the preferred embodiment.

FIG. 3 is an illustration showing an example of the configuration of position-measuring holes provided in a substrate for the measurement of a dimensional change according to examples.

### DETAILED DESCRIPTION OF THE INVENTION

Next, a preferred embodiment of the present invention will now be described in detail with reference to the drawings.

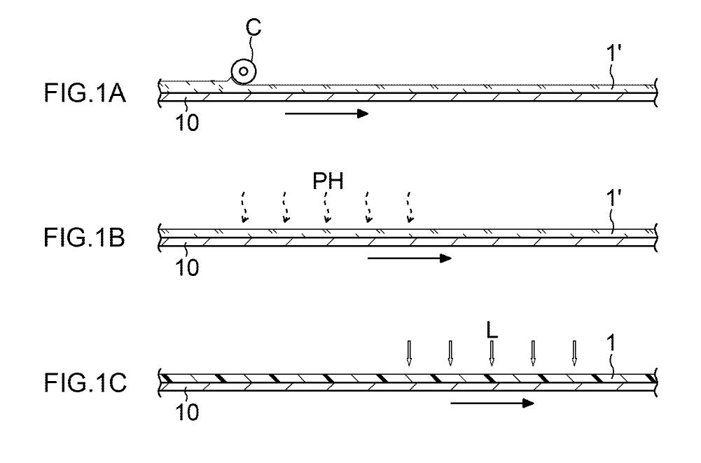

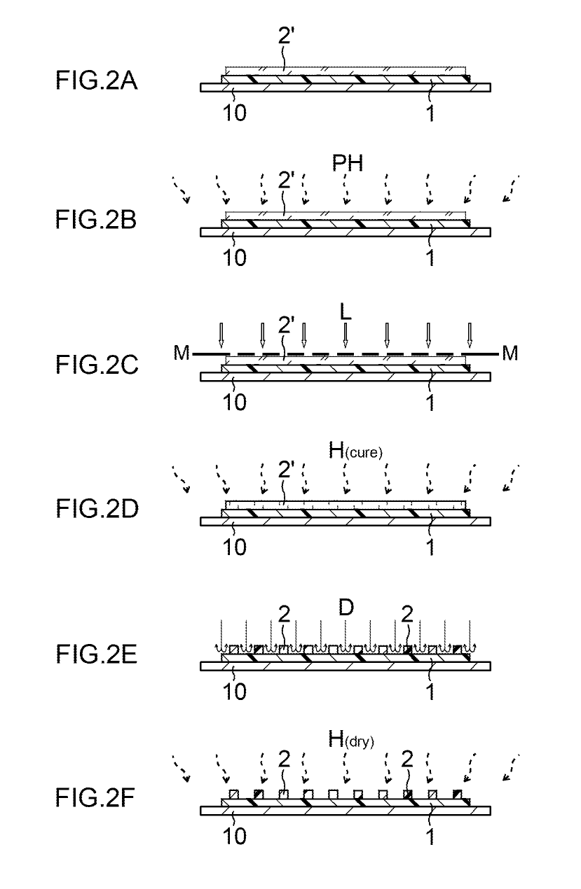

FIGS. 1A to 1C are schematic views illustrating a process for forming a cladding layer in a method of manufacturing an optical waveguide for a touch panel according to the preferred embodiment. FIGS. 2A to 2F are schematic views illustrating a process for forming cores in the aforementioned method of manufacturing an optical waveguide for a touch panel. It should be noted that FIGS. 1A to 1C are views of a manufacturing procedure of an optical waveguide produced in a step-by-step manner along a flow of processing line as seen in a direction lateral to the flow direction (indicated by solid arrows) of a product (formation material). FIGS. 2A to 2F are views of the manufacturing procedure as seen in the flow direction of the product. The product (formation material) shown in FIGS. 2A to 2F shall flow in a direction from the front side toward the back side of the paper.

First, an overview of the method of manufacturing an optical waveguide for a touch panel according to this preferred embodiment will be described.

In this manufacturing method, an elongated substrate 10 made of stainless steel is initially prepared as a substrate. As shown in FIG. 1A, while the elongated substrate 10 is unwound from a supply roll (not shown) in the direction of the arrow, a varnish 1′ containing a photosensitive resin composition (in some cases, referred to hereinafter as a “varnish”) for the formation of a cladding layer is applied onto this substrate 10 in a roll-to-roll fashion using a coating machine and the like (in a first coating step). Then, as shown in FIG. 1B, preheating PH is performed on the elongated substrate 10 and the varnish 1′ after the coating to volatilize a solvent in the photosensitive resin composition (in a first preheating step). Subsequently, as shown in FIG. 1C, the photosensitive resin composition (layer) is irradiated with irradiation light L, so that a cladding layer 1 (under cladding layer) is formed by curing (in a first film formation step).

Next, cores are formed in a manner to be described below. As shown in FIG. 2A, while the elongated substrate 10 with the cladding layer 1 formed thereon is moved, a photosensitive resin composition (a varnish 2′) for the formation of cores is applied onto this cladding layer 1 in a roll-to-roll fashion using a coating machine and the like (in a second coating step). Then, as shown in FIG. 2B, preheating PH is performed on the varnish 2′ to volatilize a solvent in the photosensitive resin composition (in a second preheating step). Then, as shown in FIG. 2C, the photosensitive resin composition (layer) is irradiated with and exposed to irradiation light L through a photomask M. Subsequently, as shown in FIG. 2D, post-heating H(cure) or the like for the completion of the curing of the photosensitive resin composition is performed. Thereafter, as shown in FIG. 2E, a developing solution D is used to dissolve away unexposed portions of the photosensitive resin composition, so that cores 2 having a predetermined pattern are formed (in a second film formation step). As shown in FIG. 2F, drying by heating H (dry) is performed on the cores 2. This provides a polymer optical waveguide in which the cladding layer 1 and the cores 2 are stacked on the substrate 10.

The method of manufacturing an optical waveguide for a touch panel according to the present preferred embodiment manufactures an optical waveguide in this manner. Metal foil of stainless steel that is less susceptible to dimensional change after the aforementioned heating treatment is used for the substrate 10 for use in the manufacture.

Next, the aforementioned manufacturing method will be described in detail.

First, the elongated substrate 10 made of stainless steel is prepared. Examples of the stainless steel used for the elongated substrate 10 include SUS301, SUS304, SUS305, SUS309, SUS310, SUS316, SUS317, SUS321, SUS347, and SUS430 in accordance with JIS Standards (Japanese Industrial Standards). In particular, SUS304 excellent in resistance to corrosion and in mechanical characteristics is preferably selected. Stainless steel foil used herein has a thickness of 12 to 100 μm, preferably 20 to 50 μm. The stainless steel foil prepared herein is in the form of an elongated tape (or in the form of a ribbon) having a width of 100 to 500 mm, preferably 250 to 350 mm, and a length on the order of 10 to 100 m. The tape-shaped elongated substrate 10 is prepared in a wound condition on a reel, a roll and the like (not shown) for ease of handling and setting to a processing machine and the like.

Next, the step of forming the cladding layer is as follows. As shown in FIG. 1A, the photosensitive resin composition (the varnish 1′) for the formation of the cladding layer 1 is applied to a predetermined region of the surface of the substrate 10 to form a layer thereof. The application of the varnish 1 is achieved, for example, by a spin coating method, a dipping method, a casting method, an injection method, an ink jet method, and a method of continuously applying the varnish 1′ in a longitudinal direction of the substrate 10 in a roll-to-roll fashion using a coating machine such as a multi-coater and the like (in the first coating step). It should be noted that FIG. 1A shows an example of the process of applying the varnish 1′ to the elongated substrate 10 while unwinding the elongated substrate 10 by using a multi-coater. The reference character C in FIG. 1A designates a coater roll.

Then, as shown in FIG. 1B, while the elongated substrate 10 coated with the varnish 1′ is moved, the preheating treatment (as indicated by dotted arrows PH, which are used below in a similar manner) is performed using an oven and the like to volatilize a volatile component such as a solvent in the varnish 1′, thereby drying the surface of the varnish 1′ (the surface of the photosensitive resin composition layer) and fixing the layer of the varnish 1′ on the substrate 10 (in the first preheating step). This preheating treatment is generally performed at 100 to 150° C. for 2 to 20 minutes.

Subsequently, as shown in FIG. 1C, while the elongated substrate 10 with the varnish 1′ fixed thereon is moved, irradiation with irradiation light (as indicated by hollow arrows L, which are used below in a similar manner) is performed to cure the varnish 1′, thereby producing the cladding layer 1 (in the first film formation step). Examples of the irradiation light for curing used herein include visible light, ultraviolet light, infrared light, X-rays, alpha rays, beta rays, gamma rays and the like. Preferably, ultraviolet light is used. A light source of the ultraviolet light may be, for example, a low-pressure mercury-vapor lamp, a high-pressure mercury-vapor lamp, an ultra-high-pressure mercury-vapor lamp and the like. The dose of the ultraviolet light is generally 10 to 10000 mJ/cm², preferably 50 to 3000 mJ/cm². The thickness of the cladding layer 1 after the curing is generally in the range of 10 to 50 μm.

It is advantageous that, when actually executed in a factory and the like, the first preheating step and the first film formation step are provided in the form of an oven (preheating treatment) zone and an ultraviolet light irradiation zone which are contiguous to a coating zone using the multi-coater for the application of the varnish 1′ on the same processing line in a continuous fashion from the viewpoints of production efficiency and process control. When this processing line is separated from that for the step of forming the cores to be described later, the elongated substrate 10 with the cladding layer 1 formed thereon is in some cases wound around a roll and the like temporarily after being allowed to cool.

Next, the step of forming the cores 2 is as follows. First, as shown in FIG. 2A, while the elongated substrate 10 on which the cladding layer 1 is formed is unwound (or subsequently to the first film formation step in which irradiation with the irradiation light is performed), the photosensitive resin composition (the varnish 2′) for the formation of the cores 2 is applied onto the cladding layer 1 continuously in a longitudinal direction of the substrate 10 in a roll-to-roll fashion using a coating machine (with reference to FIG. 1A) similar to that for the cladding layer 1, to form a layer of the varnish 2′ (in the second coating step).

Subsequently, as shown in FIG. 2B, while the elongated substrate 10 coated with the varnish 2 is moved, the preheating treatment (as indicated by dotted arrows PH) is performed using an oven and the like in a manner similar to that for the cladding layer 1, to volatilize a volatile component such as a solvent in the varnish 2, thereby drying the surface of the varnish 2′ so that the mask M to be described later is allowed to contact the surface of the varnish 2′ (in the second preheating step). This preheating treatment is generally performed at 100 to 150° C. for 2 to 20 minutes.

Then, as shown in FIG. 2C, the varnish is exposed to the irradiation light L through the photomask M having an opening corresponding to a predetermined core pattern. This photomask M is unwound from a first roll (not shown) around which the tape-shaped photomask M is wound, and is wound up around a second roll (not shown), so as to move synchronously in the direction of the flow of the elongated substrate 10 (in the direction of the manufacture of the optical waveguide). Portions of the varnish 2′ exposed to the irradiation light L through this photomask M will become the cores 2 (with reference to FIG. 2F) after the step of developing (dissolving away) unexposed portions to be described later. This will be described in detail. In the aforementioned exposure process are used, for example, contact exposure and proximity exposure which is performed with the photomask M slightly spaced apart from the layer of the varnish 2′. Also, ultraviolet light is preferably used as the irradiation light L used herein, as in the production of the cladding layer 1. When ultraviolet light is used, an exposure filter referred to as a band-pass filter is preferably used. The dose of the ultraviolet light is generally 10 to 10000 mJ/cm², preferably 50 to 3000 mJ/cm².

After the exposure process, as shown in FIG. 25, post-heating H (cure) is performed to complete the curing reaction. This post-heating H(cure) is performed at 80 to 250° C., preferably at 100 to 200° C., for ten seconds to two hours, preferably for five minutes to one hour. Thereafter, as shown in FIG. 2E, development is performed using the developing solution D to dissolve away the unexposed portions of the varnish 2′, so that the remaining portions thereof are formed into a desired pattern of the cores 2 (in the second film formation step). The development employs, for example, an immersion method, a spray method, a puddle method and the like. Examples of the developing solution D used herein include organic alkali aqueous solutions such as an aqueous solution of γ-butyrolactone and tetramethylammonium hydroxide, and inorganic alkali aqueous solutions such as sodium hydroxide and potassium hydroxide. The developing solution D and conditions for the development are selected as appropriate depending on the composition of the photosensitive resin composition.

Then, as shown in FIG. 2F, drying by heating H (dry) is performed to vaporize the developing solution D, thereby providing a polymer optical waveguide in which the cladding layer 1 and the cores 2 are stacked on the elongated substrate 10. The drying by heating H(dry) is performed at 80 to 150° C., preferably at 100 to 120° C., for ten seconds to two hours. The optical waveguide for a touch panel after the drying is wound temporarily around a roll and the like by the use of a winding machine or is cut to length subsequently to the aforementioned drying process.

The method of manufacturing an optical waveguide for a touch panel according to the present preferred embodiment uses the elongated substrate 10 made of stainless steel as the substrate for the optical waveguide to suppress a dimensional change resulting from the heating in the aforementioned process steps. Thus, the manufacturing method is less prone to cause expansion/contraction and a dimensional change during the formation of the cladding layer 1 and the cores 2, and is capable of producing the cladding layer 1 and the cores 2 in predetermined positions on the substrate 10 precisely and with high accuracy.

Also, the manufacturing method according to the present preferred embodiment employs a roll-to-roll process in which the wound elongated substrate 10 is unwound and is then wound up after the completion of the processing. This allows the manufacture of optical waveguides for a touch panel in succession with high efficiency.

Next, inventive examples of the present invention will be described in conjunction with comparative examples. It should be noted that the present invention is not limited to the inventive examples.

### EXAMPLES

An elongated substrate made of stainless steel and an elongated substrate made of resin both having a width of 300 mm were used for the examples. Structures (in inventive Example 1 and Comparative Example 1) in which a cladding layer was formed on these elongated substrates by a roll-to-roll process similar to that used in the aforementioned preferred embodiment, and structures (in inventive Example 2 and Comparative Example 2) in which cores were further formed on this cladding layer were produced. The rates of dimensional change in the substrates (products) before and after the formation of the cladding layer and before and after the formation of the cores were compared when the stainless steel substrate and the resin substrate were used.

Prior to the production of optical waveguides, materials for the formation of the cladding layer and the cores were initially prepared. The same materials were used also in Comparative Examples.

### Material for Formation of Cladding Layer

Component A: 75 parts by weight of an epoxy resin <EHPE 3150 available from Daicel Chemical Industries, Ltd.>.

Component B: 25 parts by weight of an epoxy resin <MARPROOF® G-0150M available from NOF Corporation>.

Component C: (a photo-acid generator) four parts by weight of a 50% propione carbonate solution of a triarylsulfonium salt <CPI-200K available from San-Apro Ltd.>.

The material for the formation of the cladding layer (a varnish I) was prepared by dissolving the aforementioned components A, B and C in 70 parts by weight of cyclohexanone <available from Wako Pure Chemical Industries, Ltd.>.

### Material for Formation of Cores

Component D: (a photo-cation polymerizable epoxy resin) 100 parts by weight of O-cresol novolac glycidyl ether <YDCN-700-10 available from Tohto Kasei Co., Ltd.>.

Component C: (a photo-acid generator) two parts by weight of a 50% propione carbonate solution of a triarylsulfonium salt <CPI-200K available from San-Apro Ltd.>.

The material for the formation of the cores (a varnish II) was prepared by dissolving the aforementioned components D and C in 60 parts by weight of ethyl lactate.

### Preparation of Substrate

An elongated substrate (having a length of 50 m) made of stainless steel (SUS304) and having a thickness of 20 μm and a width of 300 mm was prepared as the elongated substrate for use in the manufacture of optical waveguides in Inventive Examples 1 and 2. An elongated substrate (having a length of 50 m) made of cycloolefin polymer resin <ZEONOR® available from ZEON Corporation> and having a thickness of 100 μm and a width of 300 mm was prepared as the elongated substrate for use in the manufacture of optical waveguides in Comparative Examples 1 and 2.

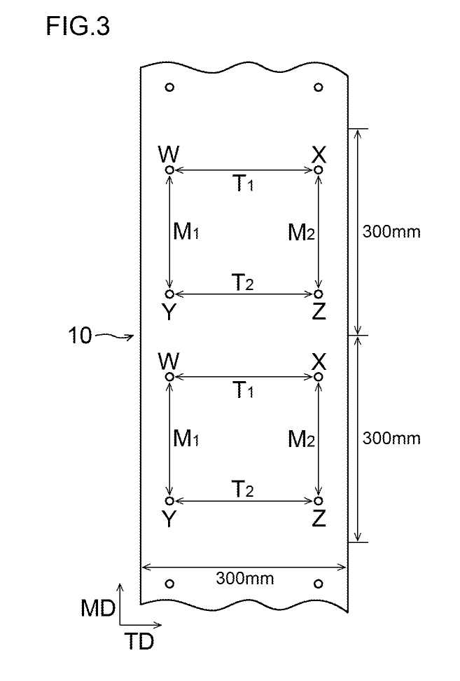

The elongated substrates made of stainless steel and cycloolefin polymer resin include sets of four position-measuring holes (having a diameter of 2.0 mm) disposed at predetermined spacings in a longitudinal direction of the substrates so that the rates of dimensional change in the substrates before and after the formation of the cladding layer or the cores are measured, as shown in FIG. 3. This allows the measurement of the dimensional change in the substrates resulting from heating associated with the formation of the cladding layer and heating associated with the formation of the cores.

### Inventive Example 1

While the elongated substrate made of stainless steel was unwound, the varnish I for the formation of the cladding layer was applied to the surface of the elongated substrate in a roll-to-roll fashion using a multi-coater, and a preheating treatment was subsequently performed using an oven at 120° C. for two minutes, thereby fixing the varnish I on the substrate. Then, an exposure process was performed on the varnish I by the irradiation thereof with ultraviolet light at 2000 mJ/cm² to completely cure the varnish I, thereby forming the cladding layer (having a thickness of 15 μm) on the substrate. The first measurement of the rate of dimensional change was made in such a manner that part of the substrate provided with the position-measuring holes was taken as a sample, and the amounts of thermal expansion/contraction (in millimeters) were measured in a first direction in which the processing of the elongated substrate proceeded (in the longitudinal direction MD of the substrate) and in a second direction (in the transverse direction TD of the substrate) perpendicular to the first direction before and after the formation of the cladding layer.

### Inventive Example 2

Next, while the substrate with the cladding layer formed thereon was moved, the varnish II for the formation of the cores was applied to the surface of the cladding layer in a roll-to-roll fashion using a multi-coater, and a preheating treatment was subsequently performed using an oven at 120° C. for two minutes, thereby drying the surface of the varnish II. Then, a synthetic quartz chrome mask (exposure mask) having an opening pattern identical in shape with the pattern of the cores was placed over a layer of the varnish II. An exposure process using a proximity exposure method was performed on the varnish II from over the mask by the irradiation thereof with ultraviolet light at 4000 mJ/cm². Thereafter, a heating (curing) treatment was performed at 120° C. for ten minutes.

Next, a development process was performed using an aqueous solution of γ-butyrolactone to dissolve away unexposed portions. Thereafter, a heating (drying) treatment was performed at 120° C. for five minutes to thereby form the cores. The second measurement of the rate of dimensional change was made in such a manner that part of the substrate provided with the position-measuring holes was taken as a sample, and the amounts of thermal expansion/contraction (in millimeters) were measured in the longitudinal direction of the substrate and in the transverse direction thereof before and after the formation of the cores on the cladding layer.

### Comparative Example 1

While the elongated substrate made of cycloolefin polymer resin was unwound, the varnish I for the formation of the cladding layer was applied to the surface of the elongated substrate in a roll-to-roll fashion using a multi-coater, and a preheating treatment was subsequently performed using an oven at 120° C. for two minutes, thereby fixing the varnish I on the substrate. Then, an exposure process was performed on the varnish I by the irradiation thereof with ultraviolet light at 2000 mJ/cm² to completely cure the varnish I, thereby forming the cladding layer (having a thickness of 15 μm) on the substrate. As in Inventive Example 1, the first measurement of the rate of dimensional change was made in such a manner that part of the substrate provided with the position-measuring holes was taken as a sample, and the amounts of thermal expansion/contraction (in millimeters) were measured in the longitudinal direction of the substrate and in the transverse direction thereof before and after the formation of the cladding layer.

### Comparative Example 2

Next, while the substrate with the cladding layer formed thereon was moved, the varnish II for the formation of the cores was applied to the surface of the cladding layer in a roll-to-roll fashion using a multi-coater, and a preheating treatment was subsequently performed using an oven at 120° C. for two minutes, thereby drying the surface of the varnish II. Then, a synthetic quartz chrome mask (exposure mask) having an opening pattern identical in shape with the pattern of the cores was placed over the varnish II. An exposure process using a proximity exposure method was performed on the varnish II from over the mask by the irradiation thereof with ultraviolet light at 4000 mJ/cm². Thereafter, a heating (curing) treatment was performed at 120° C. for ten minutes.

Next, a development process was performed using an aqueous solution of γ-butyrolactone to dissolve away unexposed portions. Thereafter, a heating (drying) treatment was performed at 120° C. for five minutes to thereby form the cores. As in Inventive Example 2, the second measurement of the rate of dimensional change was made in such a manner that part of the substrate provided with the position-measuring holes was taken as a sample, and the amounts of thermal expansion/contraction (in millimeters) were measured in the longitudinal direction of the substrate and in the transverse direction thereof before and after the formation of the cores on the cladding layer.

### Rates of Dimensional Change

The first and second measurements in respective stages of the manufacture of each optical waveguide were made as mentioned above by taking the part of the substrate (with reference to FIG. 3) in which the sets of four position-measuring holes (having a diameter of 2.0 mm) were disposed at predetermined spacings in the longitudinal direction of the substrate as a sample.

For the measurements, distances between the position-measuring holes W, X, Y and Z provided in the substrate are previously measured as references (initial values) prior to processing before the cladding layer is formed. With reference to FIG. 3, for example, a distance (M₁) between the holes W and Y and a distance (M₂) between the hoes X and Z serve as references in the first direction in which the processing of the elongated substrate proceeds (in the longitudinal direction of the substrate MD). Similarly, a distance (T₁) between the holes N and X and a distance (T₂) between the holes Y and Z serve as references in the second direction (in the transverse direction of the substrate TD) perpendicular to the first direction.

Next, the cladding layer was formed as in Inventive Example 1 and Comparative Example 1. Thereafter, similar measurements were made using the same position-measuring holes W, X, Y and Z. The values of the distances M₁ and N₂ after the formation of the cladding layer were compared with the reference values thereof prior to processing, whereby the rate of dimensional change before and after the formation of the cladding layer was calculated using the following equation.

Rate of Dimensional Change before and after Formation of Cladding Layer (%)=((Distance between Position-Measuring Holes after Formation of Cladding Layer)−(Reference Value of Distance between Position-Measuring Holes))/(Reference Value of Distance between Position-Measuring Holes)×100

Then, the cores were formed as in Inventive Example 2 and Comparative Example 2. Thereafter, similar measurements were made using the same position-measuring holes W, X, Y and Z. The values of the distances M₁ and N₂ after the formation of the cores were compared with the reference values thereof prior to processing, whereby the rate of dimensional change before and after the formation of the cores was calculated using the following equation.

Rate of Dimensional Change before and after Formation of Cores (%)=((Distance between Position-Measuring Holes after Formation of Cores)−(Reference Value of Distance between Position-Measuring Holes))/(Reference Value of Distance between Position-Measuring Holes)×100

The results of measurement of the rate of dimensional change in Inventive and Comparative Examples are listed in Tables 1 and 2 below.

TABLE 1

| | | | Inv. Ex. 2 |
|---|---|---|---|
| | Inv. Ex. 1 | | Rate of Dimensional |
| | Rate of Dimensional | | Change (%) after |
| | Change (%) before | | Formation of |
| | and after Formation | | Cladding Layer |
| | of Cladding Layer | | and Cores |
| Longitudinal | +0.021 | → | +0.004 |
| Direction (MD) | | | |
| of Substrate | | | |
| Transverse | +0.035 | → | +0.040 |
| Direction (TD) | | | |
| of Substrate | | | |

TABLE 2

| | | | Comp. Ex. 2 |
|---|---|---|---|
| | Comp. Ex. 1 | | Rate of Dimensional |
| | Rate of Dimensional | | Change (%) after |
| | Change (%) before | | Formation of |
| | and after Formation | | Cladding Layer |
| | of Cladding Layer | | and Cores |
| Longitudinal | +0.345 | → | +0.559 |
| Direction (MD) | | | |
| of Substrate | | | |
| Transverse | −0.241 | → | −0.382 |
| Direction (TD) | | | |
| of Substrate | | | |

According to Table 1 shown above, the optical waveguides in Inventive Examples 1 and 2 wherein the elongated substrate made of stainless steel (SUS304) is used as the substrate are slightly expanded both in the longitudinal direction MD and transverse direction TD of the substrate after the processing, but the amount of expansion is very small. In particular, the amount of expansion in the longitudinal direction (MD) of the substrate decreases as the procedure proceeds from the formation of the cladding layer to the formation of the cores. This shows that the method of manufacturing an optical waveguide for a touch panel is less prone to cause expansion/contraction and a dimensional change during the formation of the cladding layer and the cores, and is capable of producing the cladding layer and the cores in predetermined positions on the substrate precisely and with high accuracy.

According to Table 2 shown above, on the other hand, the optical waveguides in Comparative Examples 1 and 2 wherein the elongated substrate made of cycloolefin polymer resin <Zeonor® available from ZEON Corporation> is used as the substrate are expanded in the longitudinal direction of the substrate after the processing, and the amount of expansion increases as the procedure proceeds from the formation of the cladding layer to the formation of the cores. Also, it is found that the optical waveguides in Comparative Examples 1 and 2 are contracted in the transverse direction of the substrate, and the amount of contraction similarly increases as the procedure proceeds from the formation of the cladding layer to the formation of the cores.

The method of manufacturing an optical waveguide for a touch panel is capable of providing an optical waveguide for a touch panel which achieves a small dimensional change due to heating during processing to provide precise high-accuracy formation positions of a cladding layer and cores on a substrate.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. A method of manufacturing an optical waveguide for a touch panel, comprising:
(a) applying a first photosensitive resin composition for the formation of a cladding layer onto an elongated substrate made of stainless steel continuously in a longitudinal direction of the substrate;
(b) heating the applied first photosensitive resin composition to volatilize a solvent in the first photosensitive resin composition;
(c) irradiating the first photosensitive resin composition subjected to the step (b) with irradiation light to form a cladding layer;
(d) applying a second photosensitive resin composition for the formation of cores onto the cladding layer continuously in the longitudinal direction of the substrate;
(e) heating the applied second photosensitive resin composition to volatilize a solvent in the second photosensitive resin composition; and
(f) irradiating the second photosensitive resin composition subjected to the step (e) with irradiation light through a photomask to expose the second photosensitive resin composition to the irradiation light, thereby completing the curing of the second photosensitive resin composition, and thereafter dissolving away unexposed portions of the second photosensitive resin composition by using a developing solution to form the cores having a predetermined pattern.

2. The method according to claim 1, wherein at least the steps (a) and (b) and the steps (d) and (e) are performed continuously by a roll-to-roll process in which the elongated substrate in a wound condition is unwound and is then wound up after the completion of processing.
